(19) United States
(12) Patent Application Publication
(10) Pub. No.: US 2007/0132702 A1
(43) Pub. Date: Jun. 14, 2007

(54) Display driving integrated circuit and method for determining wire configuration of the same

(76) Inventors: Noriyuki Kajihara, Nara-shi (JP); Hiroaki Fujino, Soraku-gun (JP); Tomoaki Nakao, Yamatokoriyama-shi (JP); Yukihisa Orisaka, Nabari-shi (JP); Eisaku Miyazaki, Tokyo (JP); Michihiro Nakahara, Yamatokoriyama-shi (JP); Yasuhiro Nishida, Soraku-gun (JP); Masahiko Monomohshi, Kashihara-shi (JP)

Correspondence Address: HARNESS, DICKEY & PIERCE, P.L.C., P.O. BOX 8910, RESTON, VA, 20195, US

(21) Appl. No.: 11/633,429

(22) Filed: Dec. 5, 2006

(30) Foreign Application Priority Data
Dec. 8, 2005 (JP) 2005-355016
Oct. 18, 2006 (JP) 2006-284360

(51) Int. Cl. G09G 3/36

(52) U.S. Cl. 345/100

(57) ABSTRACT

A display driving integrated circuit includes: a tone display reference voltage generating circuit for generating 64 tone display reference voltages by resistive division on the basis of a predetermined reference voltage; D/A conversion circuits each for performing an analog conversion with respect to display data on the basis of the 64 tone display reference voltages; and 64 reference voltage wires provided in parallel, via which the 64 tone display reference voltages are supplied to the D/A conversion circuits, respectively. The 64 reference voltage wires are provided so that a potential difference corresponds to two tones or more between adjacent two reference voltage wires.

This non-provisional application claims priority under 35 U.S.C. § 119(a) on Patent Application No. 355016/2005 filed in Japan on Dec. 8, 2005, and Patent Application No. 284360/2006 filed in Japan on Oct. 18, 2006, the entire contents of which are hereby incorporated by reference.

### FIELD OF THE INVENTION

The present invention relates to (i) a display driving integrated circuit which includes: a tone display reference voltage generating circuit for generating tone display reference voltages corresponding to gray scale levels (referred to as “tone levels” hereinafter); DA conversion circuits each for performing an analog conversion of display data on the basis of the tone display reference voltages; and reference voltage wires for supplying the tone display reference voltages to the DA conversion circuits, and (ii) a method for determining a wire configuration of the display driving integrated circuit.

### BACKGROUND OF THE INVENTION

In an active matrix liquid crystal display apparatus, there has been known a tone display reference voltage generating circuit for driving liquid crystal elements by use of intermediate voltages obtained by resistive division (see Patent Citation 1 (the specification of Japanese Patent No. 3472473 (published on Oct. 8, 1999)) for example).

In the tone display reference voltage generating circuit, a resistor used for resistive division includes a resistance ratio named γ correction, and optical characteristics of the liquid crystal element are corrected based on the resistance ratio, thereby realizing a more natural tone display.

The following explains: an arrangement of a liquid crystal display apparatus having the tone display reference voltage generating circuit; an arrangement of a TFT (thin film transistor) liquid crystal panel in the liquid crystal display apparatus; a liquid crystal driving waveform of the liquid crystal panel; and an arrangement of a source driver of the liquid crystal panel.

FIG. 13 is a block diagram illustrating a main structure of a liquid crystal display apparatus 901 which is a conventional technique. FIG. 14 is a circuit diagram illustrating a main structure of a liquid crystal panel 902 included in the liquid crystal display apparatus 901. The liquid crystal display apparatus 901 is a TFT (thin film transistor) liquid crystal display apparatus which is one of typical examples of conventional active matrix liquid crystal display apparatuses. The liquid crystal display apparatus 901 includes a liquid crystal display section 934 and a liquid crystal driving circuit (liquid crystal driving section) 935 for driving the liquid crystal display section 934. The liquid crystal display section 934 includes a liquid crystal panel 902 which is a TFT liquid crystal panel. In the liquid crystal panel 902, liquid crystal display elements 912 (FIG. 14) and counter electrodes (common electrodes) 903 which will be mentioned later are provided.

On the other hand, the liquid crystal driving circuit 935 includes: a source driver section 904 and a gate driver section 906 each made of an IC (integrated circuit); a controller 908; and a liquid crystal driving power source 909. The controller 908 supplies display data D and a control signal S1 to the source driver section 904 while supplying a control signal S2 to the gate driver section 906.

The liquid crystal panel 902 is provided with: a plurality of gate signal lines 910 disposed so as to be parallel to one another with a predetermined distance between them; and a plurality of source signal lines 911 disposed so as to be parallel to one another with a predetermined distance between them in a direction perpendicular to that of the gate signal lines 910. The liquid crystal display element 912 is disposed at each crossing point of the gate signal line 910 and the source signal line 911. Each liquid crystal display element 912 includes a pixel electrode 913, a pixel capacitor 914, and a TFT 915. One end of the pixel capacitor 914 is connected with the pixel electrode 913 and the other end of the pixel capacitor 914 is connected with the counter electrode 903. The TFT 915 performs ON/OFF controls for voltage application to the pixel electrode 913. A source of the TFT 915 is connected with the source signal line 911, a gate of the TFT 915 is connected with the gate signal line 910, and a drain of the TFT 915 is connected with the pixel electrode 913.

In the liquid crystal display apparatus 901, display data supplied from outside is supplied as display data D being a digital signal to the source driver section 904 via the controller 908. The source driver section 904 time-divides the supplied display data D and latches the time-divided display data D in a plurality of source drivers 905, and then the source driver section 904 carries out a D/A (digital/analog) conversion with respect to the time-divided display data D. As a result, an analog voltage for tone display (referred to as “tone display voltage” hereinafter) is obtained. Then, the source driver section 904 supplies the tone display voltage via the source signal line 911 to a corresponding liquid crystal display element 912 in the liquid crystal panel 902.

The tone display voltage corresponding to luminosity of a pixel to be displayed is supplied from the source driver section 904 in FIG. 13 to the source signal line 911. On the other hand, scanning signals are supplied from the gate driver section 906 to the gate signal line 910 so as to sequentially turn on the TFTs 915 disposed in a column direction. Then, the tone display voltage is applied from the source signal line 911 via the TFT 15 in an ON state to the pixel electrode 913 connected with the drain of the TFT 915, so that the pixel capacitor 914 provided between the counter electrode 903 and the TFT 915 is charged. In this way, light transmittance of liquid crystal changes in response to the tone display voltage, so that pixels are displayed.

FIG. 15 is a waveform drawing illustrating a liquid crystal driving waveform at a time when an applied voltage of the liquid crystal display apparatus 901 is high. FIG. 16 is a waveform drawing illustrating a liquid crystal driving waveform at a time when an applied voltage of the liquid crystal display apparatus 901 is low. Source driver driving voltages 925a and 925b are waveforms indicating driving voltages from the source driver 905. Gate driver driving voltages 926a and 926b are waveforms indicating driving voltages from the gate driver 907. Counter electrode potentials 927a and 927b indicate potential waveforms of the counter electrode 903. Pixel electrode voltages 928a and 928b indicate voltage waveforms of the pixel electrode 913. Here, a voltage applied onto a liquid crystal material is represented by a potential difference between the pixel electrode 913 and the counter electrode 903. In FIGS. 15 and 16, the voltage applied onto a liquid crystal material is indicated by diagonal lines.

For example, in the case of FIG. 15, only during the gate driver driving voltage 926a of the gate driver section 906 (FIG. 13) maintains a “high level”, the TFT 915 (FIG. 14) is ON, and a voltage indicative of a difference between the source driver driving voltage 925a of the source driver section 904 (FIG. 13) and a counter electrode potential 927a of the counter electrode 903 is applied onto the pixel electrode 914. Thereafter, the gate driver driving voltage 926a of the gate driver section 906 becomes a “low level”, and the TFT 915 turns OFF. At that time, the pixel has the pixel capacitor 914 and therefore the above voltage is maintained.

The case of FIG. 16 is the same as that of FIG. 15. Note that, FIGS. 15 and 16 use different voltages to be applied to a liquid crystal material. To be specific, the voltage applied to the liquid crystal material is higher in FIG. 15 than that in FIG. 16. In this way, by changing a voltage applied to a liquid crystal material as an analog voltage, light transmittance of a liquid crystal is changed in an analog manner, thereby realizing multi-tone display. Note that, the number of tones which can be displayed depends on the number of choices of analog voltages applied onto a liquid crystal material.

FIG. 17 is a block diagram illustrating an outline structure of the source driver 905. FIG. 18 is a block diagram illustrating a detailed structure of the source driver 905. The source driver 905 includes a shift register 916. The shift register 916 performs a shift operation on the basis of a control signal S1, including a start pulse SP and a clock CK, which is supplied from the controller 908. Note that, a terminal S is a cascade output terminal.

The source driver 905 is provided with an input latch circuit 917. The input latch circuit 917 latches display data D being a digital signal, which includes display data (DR, DG, and DB) indicative of R (red), G (green), and B (blue). The display data latched by the input latch circuit 917 is time-divided and stored in 64 sampling memories 918 in accordance with the shift operation of the shift register 916.

Thereafter, the display data stored in each sampling memory 918 is transferred together to a hold memory 919 in response to a signal (not shown) generated in synchronization with a lateral synchronization signal supplied from the controller 908.

The source driver 905 includes a tone display reference voltage generating circuit 923. The tone display reference voltage generating circuit 923 generates tone display reference voltages corresponding to 64 tones on the basis of a voltage VR supplied from an external reference voltage generating circuit (corresponding to the liquid crystal driving power source 909 in FIG. 13).

The display data having been transmitted together to each hold memory 919 is supplied to D/A conversion circuits (digital/analog conversion circuits) 921 via a level shifter circuit 920, and is converted into analog voltage signals on the basis of tone display reference voltages corresponding to each level supplied from the tone display reference voltage generating circuit 923. The analog voltage signals are supplied, as the tone display voltages, by respective output circuits 922 from respective liquid crystal driving voltage output terminals 929 to the source signal lines 911 connected with the liquid crystal display elements 912 (FIG. 14). That is, the number of levels of tone display reference voltages generated by the tone display reference voltage generating circuit 923 is the number of tones which can be displayed.

FIG. 19 is a block diagram illustrating a structure of the tone display reference voltage generating circuit 923. The tone display reference voltage generating circuit 923 generates the tone display reference voltages so as to generate intermediate voltages. The tone display reference voltage generating circuit 923 illustrated in FIG. 19 generates 64 levels of tone display reference voltages.

The tone display reference voltage generating circuit 923 includes: terminals to which 9 levels of reference voltages (intermediate voltages) VI0, VI8, VI16, VI24, VI32, VI40, VI48, VI56, and VI63 are supplied; and 8 pieces of resistor elements R0 to R7 provided with a resistance ratio for γ correction, and 64 levels of voltage signals V0 to V63 are supplied from parts obtained by dividing the resistance element R0 into seven equal parts and are supplied from parts obtained by dividing each of the resistance elements R1 to R7 into eight equal parts.

As described above, a resistance ratio named γ correction is stored in the tone display reference voltage generating circuit 923 provided in the source driver 905 of the source driver section 904, so that a liquid crystal driving output voltage for converting into the tone display voltage has a broken line characteristic due to the resistance ratio of the γ correction. Therefore, by correcting optical characteristics of a liquid crystal material by use of the resistance ratio, it is possible to perform natural tone display in line with the optical characteristics of the liquid crystal material.

FIG. 20 is a graph illustrating characteristics of a liquid crystal driving output voltage with respect to tone display data in the tone display reference voltage generating circuit 923. A transverse axis indicates tone display data (digital input) and a longitudinal axis indicates a liquid crystal driving output voltage (analog voltage). As illustrated in FIG. 20, the broken line characteristic due to a resistance ratio of γ correction appears. By correcting optical characteristics of a liquid crystal material on the basis of the broken line characteristic, it is possible to perform natural tone display in line with the optical characteristics of the liquid crystal material.

According to the display data having been transmitted to the hold memory 919, each D/A conversion circuit 921 selects one of 64 levels of tone display reference voltages (V0 to V63) generated by the tone display reference voltage generating circuit 923 and transmits an analog level signal indicative of the tone display reference voltage thus selected to the output circuit 922, and the output circuit 922 receives the signal, performs an impedance conversion of the signal, and outputs the signal thus converted via the liquid crystal driving voltage output terminal 929.

FIG. 21 is a circuit diagram illustrating a structure of the D/A conversion circuit 921. FIG. 22(a) is a drawing explaining a structure of an analog switch 930 provided in the D/A conversion circuit 921. FIG. 22(b) is a drawing explaining an operation of the analog switch 930. FIG. 23 is a truth table showing an operation of the DA conversion circuit 921.

Reference voltage wires via which 64 levels of tone display reference voltages V0 to V63 are supplied are disposed in the order of tone display reference voltages V0, V1, V2, . . . , V62, and V63. As illustrated in FIGS. 22(a) and 22(b), each analog switch 930 includes a gate G, a source A, and a drain B. When the gate G is in “H (high level)”, the analog switch 930 is ON and the source A and the drain B are conducted to each other. When the gate G is “L (low level)”, the analog switch 930 becomes a high impedance (Z). Signals D0B, D1B, D2B, D3B, D4B, and D5B are signals obtained by inverting signals D0, D1, D2, D3, D4, and D5, respectively. The DA conversion circuit 921 outputs one of the 64 levels of tone display reference voltages V0 to V63 to an output terminal OUT.

The tone display reference voltage generating circuit 923 illustrated in FIGS. 17 and 18 exists with respect to each source driver 905, while the D/A conversion circuit 921 exists with respect to each output of the source driver 905. The number of the D/A conversion circuits 921 is the same as the number of outputs of the source driver 905. In the example illustrated in FIG. 18, 20 liquid crystal driving voltage output terminals 929 exist. Therefore, in order to supply tone display reference voltages generated by the tone display reference voltage generating circuit 923 to respective D/A conversion circuits 921, it is necessary to wire from the tone display reference voltage generating circuit 923 to respective D/A conversion circuit 921.

Recently, a liquid crystal display driver has multi-tones and multi-outputs (e.g. 256 tones and 480 outputs). In testing the source driver 5 which is a liquid crystal driver having such multi-tones and multi-outputs, it is necessary to test whether all tone voltage values supplied from the respective D/A conversion circuits 921 are voltage values having been correctly converted so as to correspond to digital image data in each level.

The reason is as follows: the source driver 5 is an integrated circuit in which minute circuits are integrated on silicon and has minute wires, and therefore minute foreign matters generated in a fabrication process cause an insufficient operation of the integrated circuit.

As illustrated in FIG. 18, each of reference voltage wires constituting a reference voltage wire group 924 has a length substantially identical with that of a longer side of the source driver. The number of reference voltage wires increases as the source driver has more number of tones, and therefore the reference voltage wires have a larger area in a chip. Consequently, minute foreign matters often cause an insufficient operation.

FIG. 24 is a drawing for explaining changes in voltages of reference voltage wires in a case where a foreign matter 936 gets caught between adjacent reference voltage wires. FIGS. 25(a) and 25(b) are tables for explaining what influence a resistance value of the foreign matter 936 has on an output voltage from the D/A conversion circuit 921.

FIG. 24 illustrates an example in which the foreign matter 936 gets caught between a reference voltage wire via which a tone display reference voltage V16 is supplied and a reference voltage wire via which a tone display reference voltage V17 is supplied. A potential difference between the two reference voltage wires is a potential difference corresponding to 1 tone.

As illustrated in FIG. 25(a), in the tone display reference voltage generating circuit 923 for dividing 0V to 5V by 63 pieces of equivalent resistors so as to generate 64 levels of tones, if the whole resistance value is set to 20 kΩ (20,000Ω), a resistance value for generating 1 tone is approximately 317.46Ω (20 kΩ÷63≈317.46Ω), so that a voltage for 1 tone is approximately 79.37 mV (5V×317.46Ω÷20 kΩ=0.07937V).

When the foreign matter 936 having a resistance value of 1 kΩ (1000Ω) gets caught between adjacent reference voltage wires whose potential difference corresponds to 1 tone, it is considered that a resistance 317.46Ω corresponding to 1 tone and a resistance of a foreign matter are connected with each other in parallel, so that a combined resistance between the adjacent reference voltage wires where the foreign matter 936 gets caught is approximately 240.96Ω (1/((1/317.46)+(1/1 kΩ))≈240.96Ω). Consequently, a change from the original resistance value 317.46Ω corresponding to 1 tone is 76.5Ω. Consequently, the whole resistance value changes from 20 kΩ to 19.9235 kΩ (approximately 19924Ω). At that time, a voltage between the adjacent reference wires where the foreign matter gets caught is approximately 60.47 mV (5V×240.96Ω÷19.9235 kΩ=0.0605) and therefore a change from the original voltage 79.37 mV due to the foreign matter 936 is 18.9 mV (79.37−60.47=18.9).

Voltage resolution of a measurement tester is approximately 1 mV (according to the handbook of a tester TS6700 manufactured by Yokogawa Electronic Corporation for example (non patent citation 1 (Yokogawa Electronic Corporation Tester Business Headquarters, “TS6700 handbook”, a manual attached to a tester TS6700 manufactured by Yokogawa Electronic Corporation, Yokogawa Electronic Corporation, June 2001, page 359)), a voltage resolution of the tester is 977 μV in a measurement range of −8V to +8V), so that it is possible to detect the changed voltage 18.9 mV and therefore it is possible to judge that the source driver 5 is defective.

On the other hand, as illustrated in FIG. 25(b), when a foreign matter 936 having a resistance value of 100 kΩ (100,000Ω) gets caught between reference voltage wires whose potential difference corresponds to 1 tone, it is considered that a resistance 317.5Ω corresponding to 1 tone and a resistance of a foreign matter 936 are connected with each other in parallel, so that a combined resistance between the adjacent reference voltage wires where the foreign matter 936 gets caught is approximately 316.46% (1/((1/317.46)+(1/100 k))=316.46), which drops from the original resistance value 317.46Ω corresponding to 1 tone by 1Ω. Consequently, the whole resistance value changes from 20 kΩ to 19.999 kΩ (19999Ω). A voltage between the adjacent reference voltage wires where the foreign matter gets caught is approximately 79.12 mV (5V×316.46Ω÷19.999 kΩ≈0.7912) and therefore a change from the original voltage 79.37 mV is only 0.25 mV (79.37−79.12=0.25). Therefore, with the voltage resolution of the measurement tester, namely, 1 mV, it is impossible to detect a changed voltage due to the foreign matter 936 and therefore it is impossible to detect the foreign matter 936. Such change in a voltage of 1 mV or less does not have an influence on display on a liquid crystal panel. However, it is necessary to detect a foreign matter so as to increase quality of a source driver.

### SUMMARY OF THE INVENTION

The present invention was made in view of the foregoing problems. An object of the present invention is to provide (i) a display driving integrated circuit capable of surely detecting a foreign matter having a large resistance which gets caught between adjacent reference voltage wires, thereby increasing the quality of the display driving integrated circuit, and (ii) a method for determining a wire configuration of the display driving integrated circuit.

In order to achieve the object, the display driving integrated circuit of the present invention includes: a tone display reference voltage generating circuit for generating n tone display reference voltages (n: an integer of two or more); D/A conversion circuits each for performing an analog conversion with respect to display data, based on the n tone display reference voltages; and n reference voltage wires, provided in parallel, via which the n tone display reference voltages are supplied to the D/A conversion circuits, respectively, the n reference voltage wires being configured so that a potential difference corresponds to two tones or more between adjacent two reference voltage wires.

With the arrangement, the n reference voltage wires are configured so that a potential difference corresponds to two tones or more between adjacent two reference voltage wires. Consequently, a potential difference between adjacent two reference voltage wires is large. Therefore, even if a foreign matter having a large resistance value gets caught between adjacent reference voltage wires, a potential value changed by the foreign matter between the reference voltage wires is larger than a resolution of a tester. Therefore, it is possible to surely detect a foreign matter having a large resistance value which gets caught between adjacent reference voltage wires, so that it is possible to increase the quality of the display driving integrated circuit.

In order to achieve the object, the method of the present invention for determining a wire configuration of a display driving integrated circuit is a method, comprising the step of determining a configuration of n (n: an integer of two or more) reference voltage wires provided in parallel, via which reference voltage wires n tone display reference voltages are supplied, so that a potential difference corresponds to two tones or more between adjacent two reference voltage wires.

With the arrangement, the n reference voltage wires provided in parallel, via which the n tone display reference voltages are supplied, are configured so that a potential difference corresponds to two tones or more between adjacent two reference voltage wires. Consequently, a potential difference between adjacent two reference voltage wires is large. Therefore, even if a foreign matter having a large resistance value gets caught between adjacent reference voltage wires, a potential value changed by the foreign matter between the reference voltage wires is larger than a resolution of a tester. Therefore, it is possible to surely detect a foreign matter having a large resistance value which gets caught between adjacent reference voltage wires, so that it is possible to increase the quality of the display driving integrated circuit.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating a main structure of a liquid crystal, display apparatus in an embodiment of the present invention.

FIG. 2 is a circuit diagram illustrating a main structure of a liquid crystal panel included in the liquid crystal display apparatus.

FIG. 3 is a waveform diagram illustrating a liquid crystal driving waveform at a time when an applied voltage of the liquid crystal display apparatus is high.

FIG. 4 is a waveform diagram illustrating a liquid crystal driving waveform at a time when an applied voltage of the liquid crystal display apparatus is low.

FIG. 5 is a block diagram illustrating an outline of a source driver included in the liquid crystal display apparatus.

FIG. 6 is a block diagram illustrating a detailed structure of the source driver.

FIG. 7 is a block diagram illustrating a structure of a tone display reference voltage generating circuit included in the source driver.

FIG. 8 is a circuit diagram illustrating a structure of a D/A conversion circuit included in the source driver.

FIG. 9(a) is a drawing for explaining a structure of an analog switch included in the D/A conversion circuit. FIG. 9(b) is a drawing for explaining an operation of the analog switch.

FIG. 10 is a truth table illustrating an operation of the D/A conversion circuit.

FIG. 11 is a circuit diagram illustrating another arrangement of the D/A conversion circuit included in the source driver.

FIG. 12 is a truth table illustrating an operation of another arrangement of the D/A conversion circuit.

FIG. 13 is a block diagram illustrating a main structure of a conventional liquid crystal display apparatus.

FIG. 14 is a circuit diagram illustrating a main structure of a liquid crystal panel included in the liquid crystal display apparatus.

FIG. 15 is a waveform diagram illustrating a liquid crystal driving waveform at a time when an applied voltage of the liquid crystal display apparatus is high.

FIG. 16 is a waveform diagram illustrating a liquid crystal driving waveform at a time when an applied voltage of the liquid crystal display apparatus is low.

FIG. 17 is a block diagram illustrating an outline of a source driver included in the liquid crystal display apparatus.

FIG. 18 is a block diagram illustrating a detailed structure of the source driver.

FIG. 19 is a block diagram illustrating a structure of a tone display reference voltage generating circuit included in the source driver.

FIG. 20 is a graph illustrating a characteristic of a liquid crystal driving output voltage with respect to tone display data in the tone display reference voltage generating circuit.

FIG. 21 is a circuit diagram illustrating a structure of a D/A conversion circuit included in the source driver.

FIG. 22(a) is a drawing for explaining a structure of an analog switch included in the D/A conversion circuit. FIG. 22(b) is a drawing for explaining an operation of the analog switch.

FIG. 23 is a truth table illustrating an operation of the D/A conversion circuit.

FIG. 24 is a drawing for explaining a foreign matter which gets caught between adjacent reference voltage wires.

FIGS. 25(a) and 25(b) are tables explaining influences of foreign matters which get caught between adjacent reference voltage wires on output voltages from D/A conversion circuits.

FIG. 26 is a block diagram illustrating another structure of the tone display reference voltage generating circuit.

### DESCRIPTION OF THE EMBODIMENTS

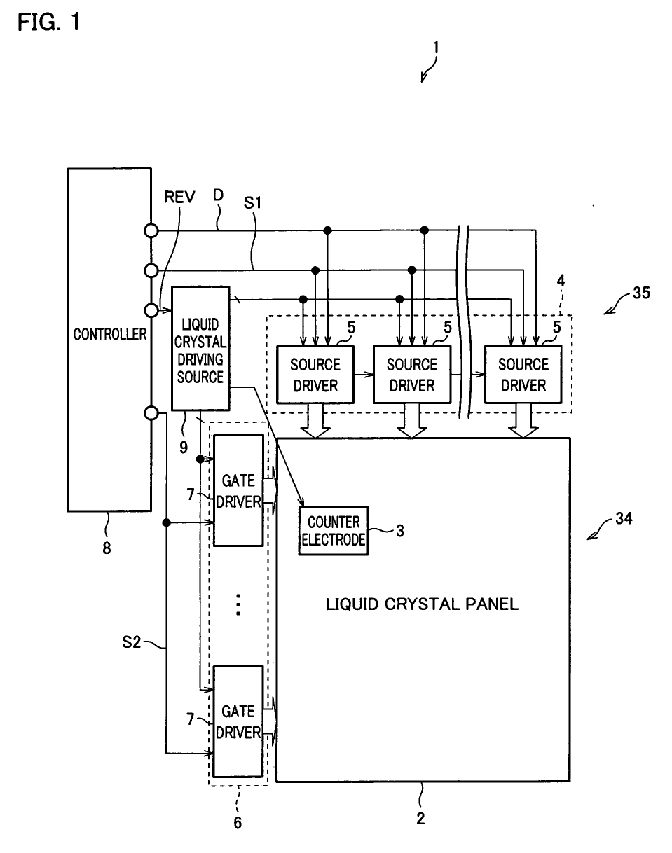

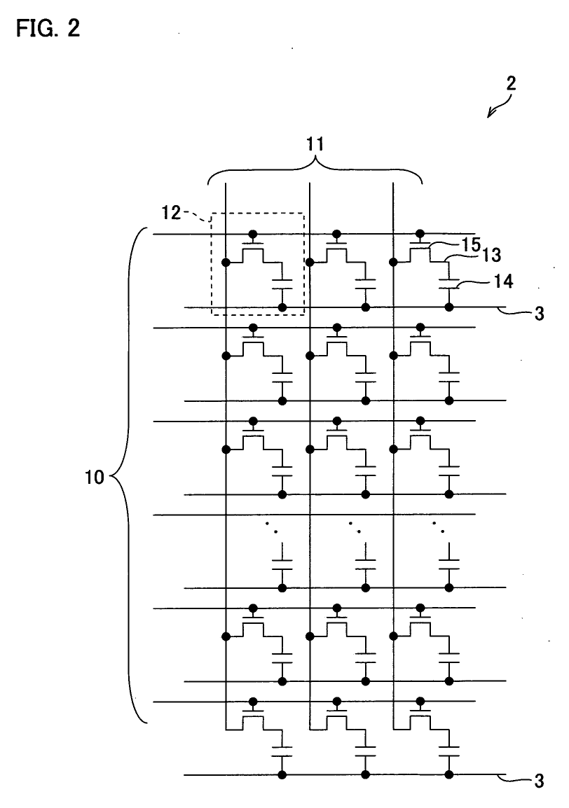

The following explains an embodiment of the present invention with reference to FIGS. 1 to 12. FIG. 1 is a block diagram illustrating a main structure of a liquid crystal display apparatus 1 in an embodiment of the present invention. FIG. 2 is a circuit diagram illustrating a main structure of a liquid crystal panel 2 included in the liquid crystal display apparatus 1.

The liquid crystal display apparatus 1 is a TFT (thin film transistor) liquid crystal display apparatus, which is one of typical examples of active matrix liquid crystal display apparatuses. The liquid crystal display apparatus 1 includes a liquid crystal display section 34 and a liquid crystal driving circuit (liquid crystal driving section) 35 for driving the liquid crystal display section 34. The liquid crystal display section 34 includes a liquid crystal panel 2 which is a TFT liquid crystal panel. In the liquid crystal panel 2, liquid crystal display elements 12 (FIG. 2) and counter electrodes (common electrodes) 3 which will be detailed later are provided.

On the other hand, the liquid crystal driving circuit 35 includes: a source driver section 4 and a gate driver section 6 each made of an IC (integrated circuit); a controller 8; and a liquid crystal driving power source 9. The controller 8 supplies display data D and a control signal S1 to the source driver section 4 while supplying a control signal S2 to the gate driver section 6.

The liquid crystal panel 2 is provided with: a plurality of gate signal lines 10 disposed so as to be parallel to one another with a predetermined distance between them; and a plurality of source signal lines 11 disposed so as to be parallel to one another with a predetermined distance between them in a direction perpendicular to that of the gate signal lines 10. The liquid crystal display element 12 is disposed at each crossing point of the gate signal line 10 and the source signal line 11. Each liquid crystal display element 12 includes a pixel electrode 13, a pixel capacitor 14, and a TFT 15. One end of the pixel capacitor 14 is connected with the pixel electrode 13 and the other end of the pixel capacitor 14 is connected with the counter electrode 3. The TFT 15 performs ON/OFF controls for voltage application to the pixel electrode 13. A source of the TFT 15 is connected with the source signal line 11, a gate of the TFT 15 is connected with the gate signal line 10, and a drain of the TFT 15 is connected with the pixel electrode 13.

In the liquid crystal display apparatus 1, display data supplied from outside is supplied as display data D being a digital signal to the source driver section 4 via the controller 8. The source driver section 4 time-divides the supplied display data D and latches the time-divided display data D in a plurality of source drivers 5, and then the source driver section 4 carries out a D/A (digital/analog) conversion with respect to the time-divided display data D. As a result, an analog voltage for tone display (referred to as “tone display voltage” hereinafter) is obtained. Then, the source driver section 4 supplies the tone display voltage via the source signal line 11 to a corresponding liquid crystal display element 12 in the liquid crystal panel 2.

The tone display voltage corresponding to luminosity of a pixel to be displayed is supplied from the source driver section 4 in FIG. 1 to the source signal lines 11. On the other hand, scanning signals are supplied from the gate driver section 6 to the gate signal lines 10 so as to sequentially turn on the TFTs 15 disposed in a column direction. Then, the tone display voltage is applied from the source signal line 11 via the TFT 15 in an ON state to the pixel electrode 13 connected with the drain of the TFT 15, so that the pixel capacitor 14 provided between the counter electrode 3 and the TFT 15 is charged. Therefore, light transmittance of the liquid crystal changes in response to the tone display voltage, so that pixels are displayed.

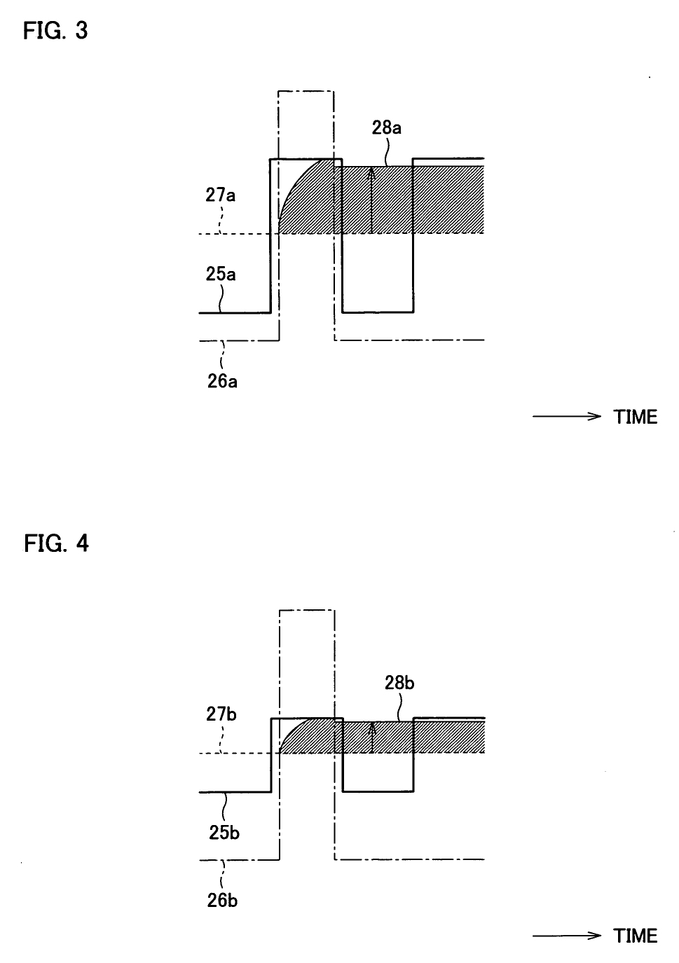

FIG. 3 is a waveform drawing illustrating a liquid crystal driving waveform at a time when an applied voltage of the liquid crystal display apparatus 1 is high. FIG. 4 is a waveform drawing illustrating a liquid crystal driving waveform at a time when an applied voltage is low. Source driver driving voltages 25a and 25b are waveforms indicating driving voltages from the source driver 5. Gate driver driving voltages 26a and 26b are waveforms indicating driving voltages from the gate driver 7. Counter electrode potentials 27a and 27b indicate potential waveforms of the counter electrode 3. Pixel electrode voltages 28a and 28b indicate voltage waveforms of the pixel electrode 3. Here, a voltage applied onto a liquid crystal material is represented by a potential difference between the pixel electrode 13 and the counter electrode 3. In FIGS. 3 and 4, the voltage applied onto a liquid crystal material is indicated by diagonal lines.

For example, in the case of FIG. 3, only during the gate driver driving voltage 26a of the gate driver section 6 (FIG. 1) maintains a “high level”, the TFT 15 (FIG. 2) is ON, and a voltage indicative of a difference between the source driver driving voltage 25a of the source driver section 4 (FIG. 1) and a counter electrode potential 27a of the counter electrode 3 is applied onto the pixel electrode 14. Thereafter, the gate driver driving voltage 26a of the gate driver section 6 becomes a “low level”, and the TFT 15 turns OFF. At that time, the pixel has the pixel capacitor 14 and therefore the above voltage is maintained.

The case of FIG. 4 is the same as that of FIG. 3. Note that, FIGS. 3 and 4 use different voltages to be applied to a liquid crystal material. To be specific, the voltage applied to the liquid crystal material is higher in FIG. 3 than that in FIG. 4. In this way, by changing a voltage applied onto a liquid crystal material as an analog voltage, light transmittance of a liquid crystal is changed in an analog manner, thereby realizing multi-tone display. Note that, the number of tones which can be displayed depends on the number of choices of analog voltages applied onto the liquid crystal material.

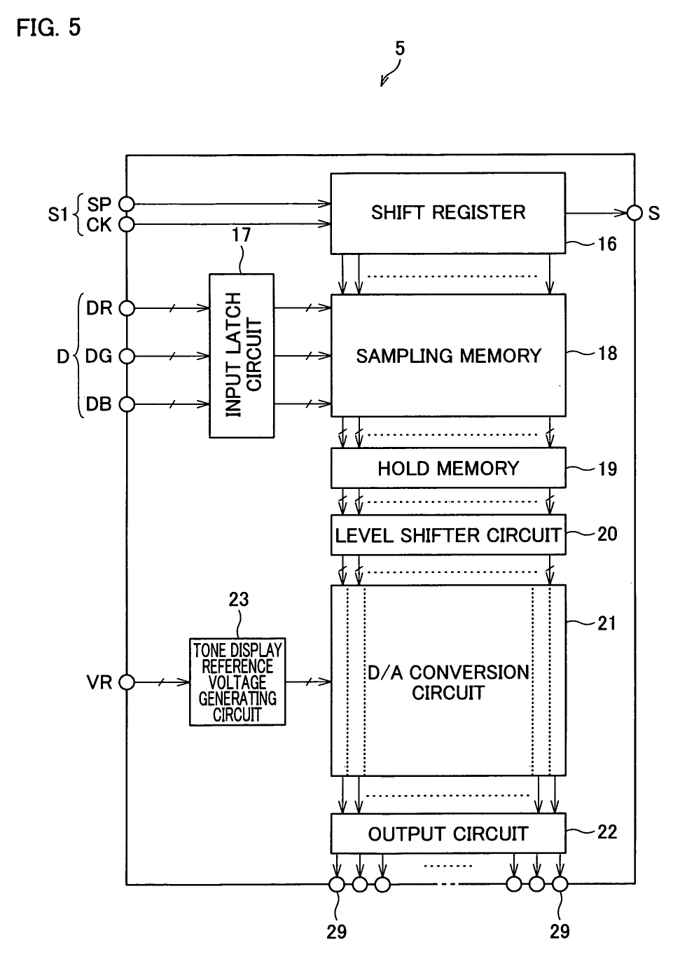

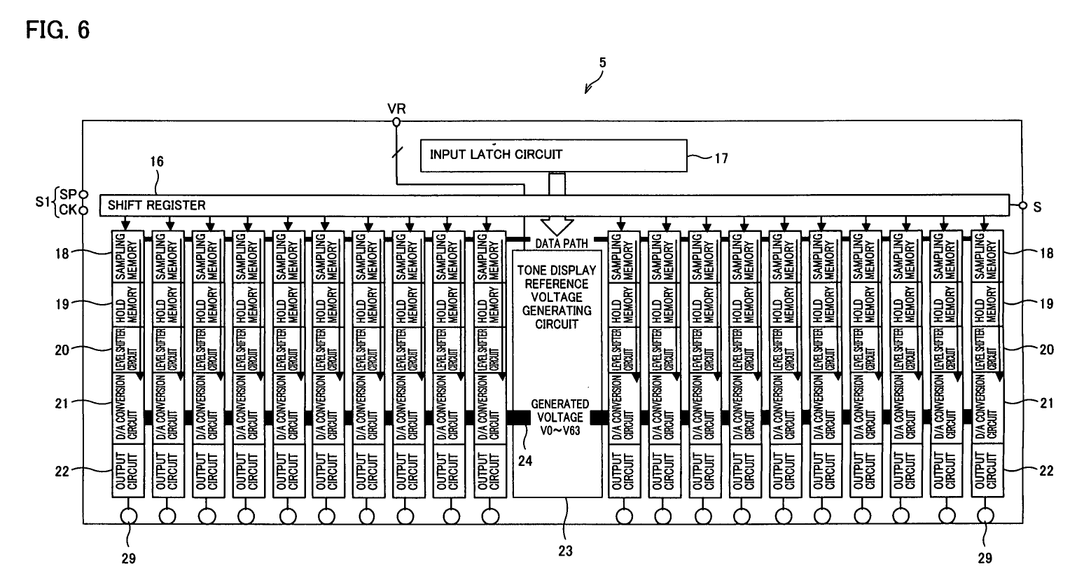

FIG. 5 is a block diagram illustrating an outline structure of the source driver 5. FIG. 6 is a block diagram illustrating a detailed structure of the source driver 5. The source driver 5 includes a shift register 16. The shift register 16 performs a shift operation on the basis of a control signal S1, including a start pulse SP and a clock CK, which is supplied form the controller 8. Note that, a terminal S is a cascade output terminal.

The source driver 5 is provided with an input latch circuit 17. The input latch circuit 17 latches display data D being a digital signal, which includes display data (DR, DG, and DB) indicative of R (red), G (green), and B (blue). The display data latched by the input latch circuit 17 is time-divided and stored in 64 sampling memories 18 in accordance with the shift operation of the shift register 16.

Thereafter, the display data stored in each sampling memory 18 is transferred together to a hold memory 19 in response to a signal (not shown) generated in synchronization with a lateral synchronization signal supplied from the controller 8.

The source driver 5 includes a tone display reference voltage generating circuit 23. The tone display reference voltage generating circuit 23 generates tone display reference voltages corresponding to 64 tones on the basis of a voltage VR supplied from an external reference voltage generating circuit (corresponding to the liquid crystal driving power source 9 in FIG. 1).

The display data having been transmitted together to each hold memory 19 is supplied to D/A conversion circuits (digital/analog conversion circuits) 21 via a level shifter circuit 20, and is converted into analog voltage signals on the basis of tone display reference voltages corresponding to each level supplied from the tone display reference voltage generating circuit 23. The analog voltage signals are supplied by respective output circuits 22 from respective liquid crystal driving voltage output terminals 29 to the source signal lines 11 connected with the liquid crystal display elements 12 (FIG. 2). That is, the number of levels (e.g. 64 levels) of tone display reference voltages generated by the tone display reference voltage generating circuit 23 is the number of tones (e.g. 64 tones) which can be displayed.

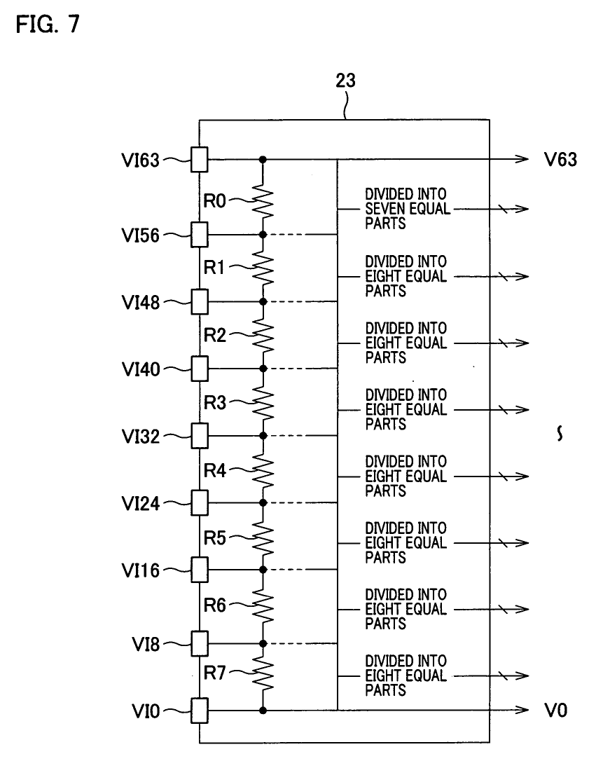

FIG. 7 is a block diagram illustrating a structure of the tone display reference voltage generating circuit 23 provided in the source driver 5. The tone display reference voltage generating circuit 23 generates the tone display reference voltages so as to generate intermediate voltages. The tone display reference voltage generating circuit 23 illustrated in FIG. 7 generates 64 levels of tone display reference voltages.

The tone display reference voltage generating circuit 23 includes: terminals to which 9 levels of reference voltages (intermediate voltages) VI0, V18, VI16, V124, V132, VI40, V148, VI56, and V163 are supplied; and 8 pieces of resistor elements R0, R1, R2, R3, R4, R5, R6, and R7 provided in series with resistance ratio for γ correction, and 64 levels of voltage signals (tone display reference voltages V0, V1, V2, . . . , V61, V62, and V63) are supplied from parts obtained by dividing the resistance element R0 into seven equal parts and are supplied from parts obtained by dividing each of the resistance elements R1 to R7 into eight equal parts.

As described above, a resistance ratio named γ correction is stored in the tone display reference voltage generating circuit 23 provided in the source driver 5, so that a liquid crystal driving output voltage for converting into the tone display voltage has a broken line characteristic due to the resistance ratio of the γ correction. Therefore, by correcting optical characteristics of a liquid crystal material by use of the resistance ratio, it is possible to perform natural tone display in line with the optical characteristics of the liquid crystal material.

According to the display data having been transmitted to the hold memory 19, each D/A conversion circuit 21 selects one of 64 levels of tone display reference voltages (V0 to V63) generated by the tone display reference voltage generating circuit 23 and transmits an analog level signal indicative of the tone display reference voltage thus selected to the output circuit 22, and the output circuit 22 receives the signal, performs an impedance conversion of the signal, and outputs the signal thus converted via the liquid crystal driving voltage output terminal 29.

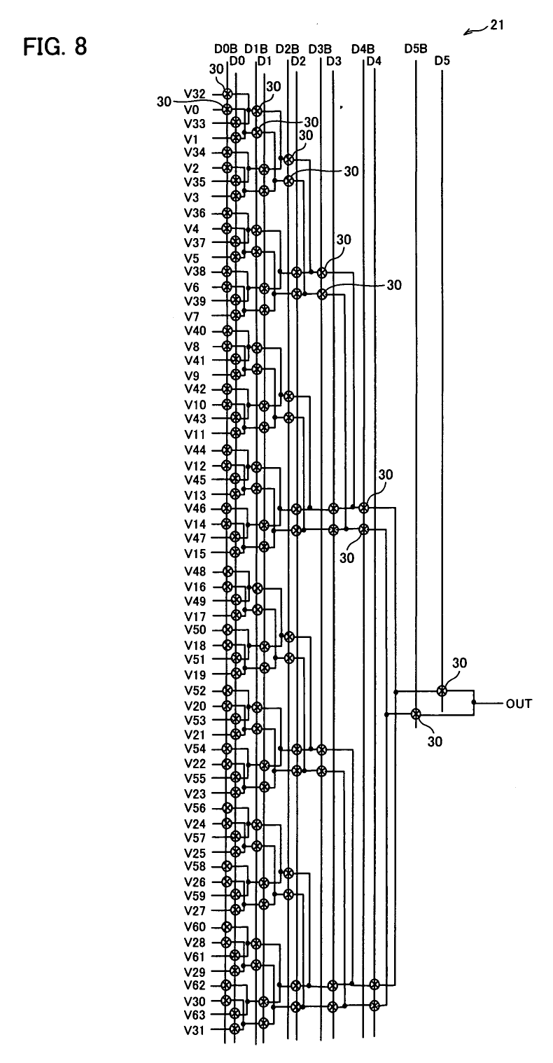

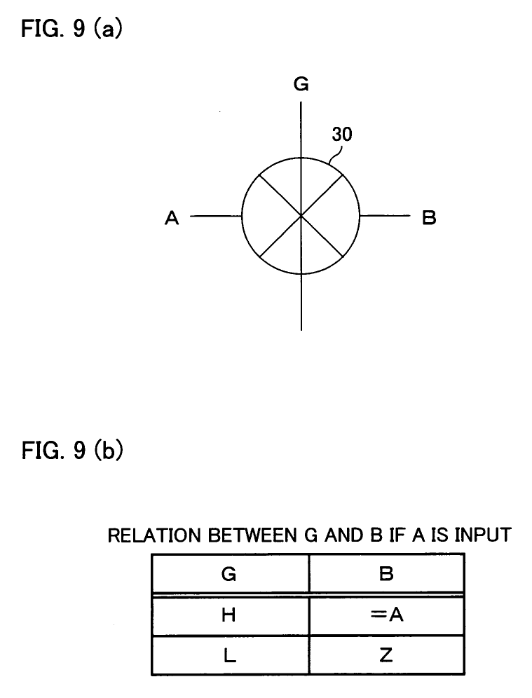

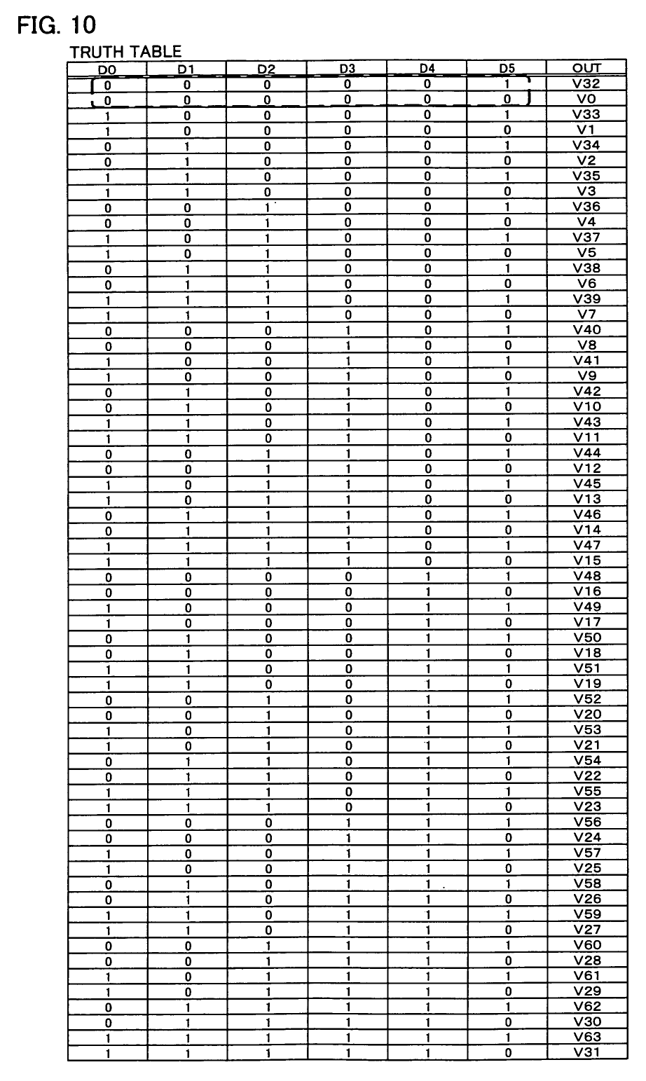

FIG. 8 is a circuit diagram illustrating a structure of the D/A conversion circuit 21 provided in the source driver 5. FIG. 9(a) is a drawing explaining a structure of an analog switch 30 provided in the D/A conversion circuit 21. FIG. 9(b) is a drawing explaining an operation of the analog switch 30. FIG. 10 is a truth table showing an operation of the DA conversion circuit 21.

The D/A conversion circuit 21 is connected with 64 reference voltage wires via which 64 levels of the tone display reference voltages V0 to V63 are supplied from the tone display reference voltage generating circuit 23. A tone display reference voltage Vk (0≦k≦63) is a tone display reference voltage corresponding to (k+1)-tone. Therefore, for example, the tone display reference voltage V0 corresponds to 1-tone, the tone display reference voltage V1 corresponds to 2-tone, and the tone display reference voltage V2 corresponds to 3-tone. Further, the tone display reference voltage V31 corresponds to 32-tone, and the tone display reference voltage V32 corresponds to 33-tone. Further, the tone display reference voltage V62 corresponds to 63-tone, and the tone display reference voltage V63 corresponds to 64-tone.

The 64 reference voltage wires extend from the tone display reference voltage generating circuit 23 to the D/A conversion circuit 21 so as to be parallel to one another, and the 64 reference voltage wires are disposed so that tones of tone display reference voltages supplied from the tone display reference voltage generating circuit 23 to the D/A conversion circuit 21 via the respective reference voltage wires are disposed in the order of “(n/2+1)-tone, 1-tone, (n/2+2)-tone, 2-tone, . . . , (n/2+(n/2−1))-tone, (n/2−1)-tone, (n/2+n/2)-tone, and (n/2)-tone”.

In the example of FIG. 8, n=64. Therefore, the 64 reference voltage wires are configured in the order of “33-tone (tone display reference voltage V32), 1-tone (tone display reference voltage V0), 34-tone (tone display reference voltage V33), 2-tone (tone display reference voltage V1), . . . , 63-tone (tone display reference voltage V62), 31-tone (tone display reference voltage V30), 64-tone (tone display reference voltage V63), and 32-tone (tone display reference voltage V31).

Consequently, a potential difference between adjacent two reference voltage wires is a potential difference corresponding to 32 tones or a potential difference corresponding to 33 tones, and therefore a potential difference corresponding to 32 tones or more exists between adjacent two reference voltage wires.

Here, assuming that a foreign matter having a large resistance value of 100 kΩ gets caught between two reference voltage wires between which a potential difference corresponding to 32 tones exists (for example, between a reference voltage wire having a tone display reference voltage V32 and a reference voltage wire having a tone display reference voltage V0).

When there is no foreign matter, the potential difference corresponding to 32 tones between the reference voltage wire having the tone display reference voltage V32 and the reference voltage wire having the tone display reference voltage V0 is 2539.84 mV (79.37 mV×32). A value of a combined resistance between the reference voltage wire having the tone display reference voltage V32 and the reference voltage wire having the tone display reference voltage V0 at a time when the foreign matter having a large resistance value of 100 kΩ gets caught is approximately 9090Ω (1/((1/(317.46×32))+(1/100 k))≈9090). Therefore, the resistance value between the reference voltage wire having the tone display reference voltage V32 and the reference voltage wire having the tone display reference voltage V0 changes from the original resistance value corresponding to 32 tones 10158.72Ω (=317.46Ω×32) by 1068.72Ω.

Consequently, the whole resistance value changes from 20 kΩ to 18.931 kΩ. Therefore, a voltage between the reference voltage wire having the tone display reference voltage V32 and the reference voltage wire having the tone display reference voltage V0 is approximately 2400 mV (5V×9.090 kΩ÷18.931 kΩ≈2400 mV). Accordingly, a change from the original voltage 2539.84 mV is 239.84 mV (2539.84 mV−2400 mV=239.84 mV), which is greatly larger than the resolution of a tester, namely, 1 mV. Therefore, it is possible to detect the foreign matter having a large resistance of 100 kΩ.

As illustrated in FIG. 9(a), each analog switch 30 includes a gate G, a source A, and a drain B. When the gate G is in “H (high level)”, the analog switch 30 turns ON and the source A and the drain B are conducted to each other. When the gate G is “L (low level)”, the analog switch 30 becomes a high impedance (Z). Signals DOB, D1B, D2B, D3B, D4B, and D5B are signals obtained by inverting signals D0, D1, D2, D3, D4, and D5, respectively. According to the truth table in FIG. 10, the DA conversion circuit 21 outputs one of the 64 levels of tone display reference voltages V0 to V63 to an output terminal OUT.

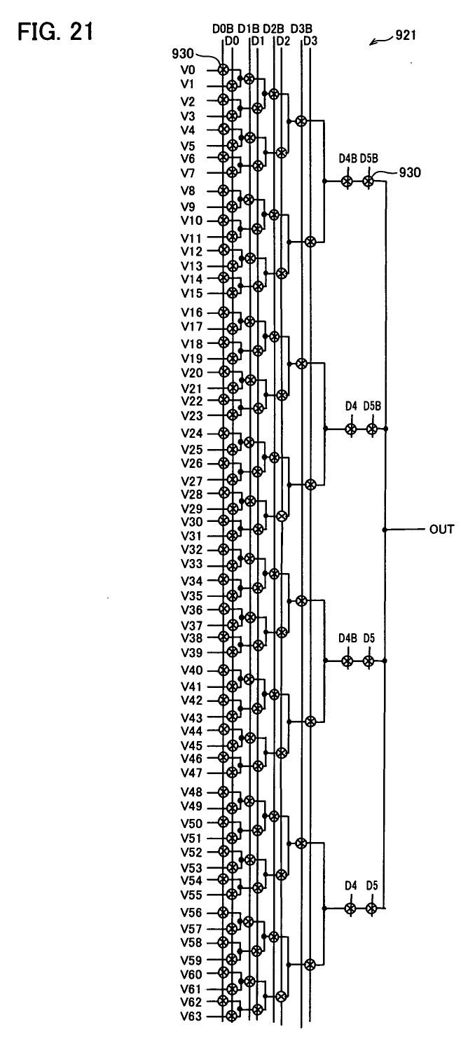

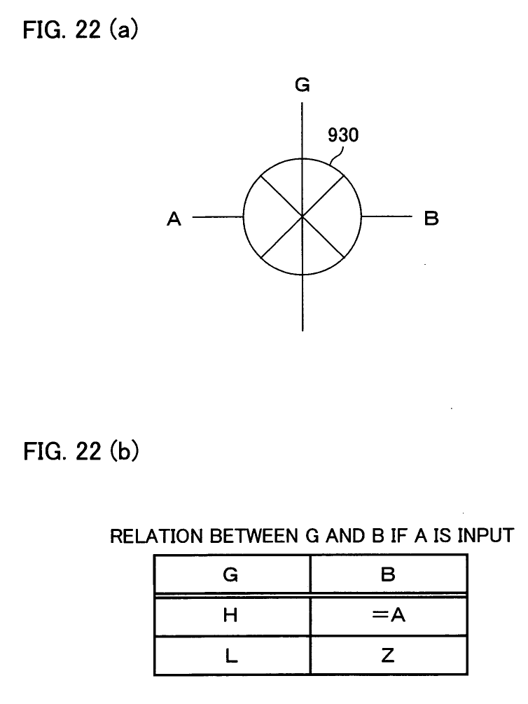

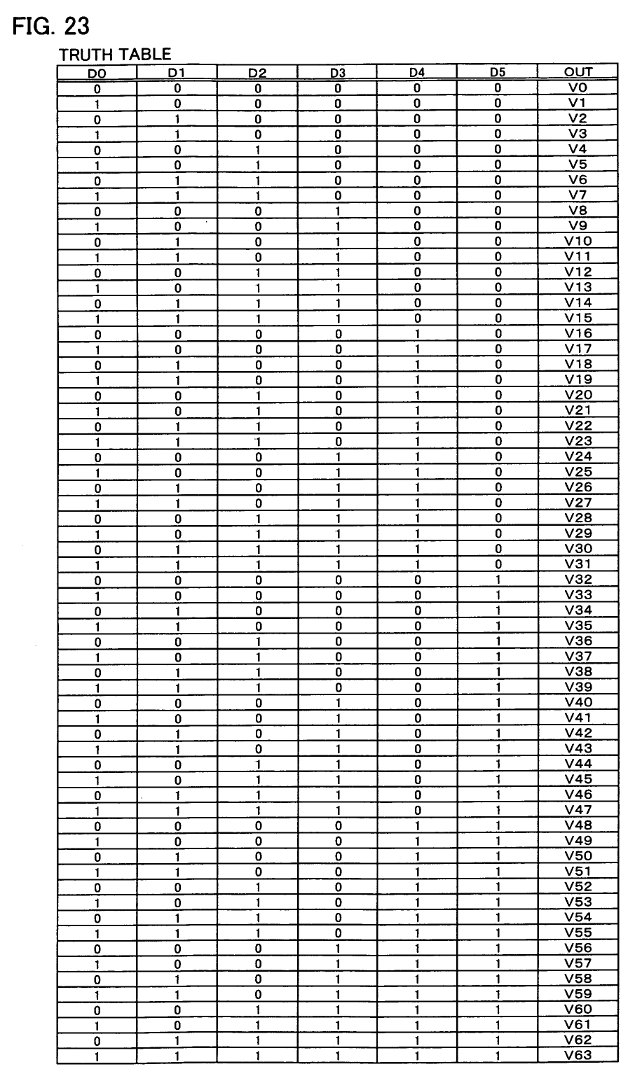

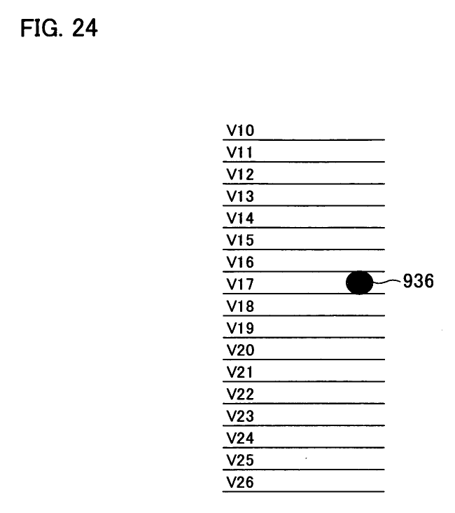

The following studies a case where a net list (wire information of a transistor) is extracted from the circuit diagram of the present embodiment in FIG. 8 and the conventional circuit diagram in FIG. 21. The order of wires corresponding to the tone display reference voltages V0 to V63 is not considered in the net list, and therefore the net list of the circuit diagram of the present embodiment is identical with the net list of the conventional circuit diagram. Consequently, in a case of performing a layout for increasing a potential difference between tones, which is an object of the present invention, it is necessary to extract, from the circuit diagram in FIG. 8, (i) wire information of a transistor, which is information of a net list, and (ii) information of the order of wires corresponding to the tone display reference voltages V0 to V63. The wire configuration determining method (development method) as described above allows for generation of the information of the order.

That is, if a wire configuration in which the development method is included in algorithm is performed with respect to the conventional circuit diagram in FIG. 21, then it is easy to obtain (i) a configuration of reference voltage wires, which allows for an increase in a potential difference between adjacent reference voltage wires and (ii) a configuration of a transistor, which is appropriate to the layout. The method is particularly important when an automatic wire configuration by use of a computer is performed. The method is also applicable to a case where the layout is performed by human.

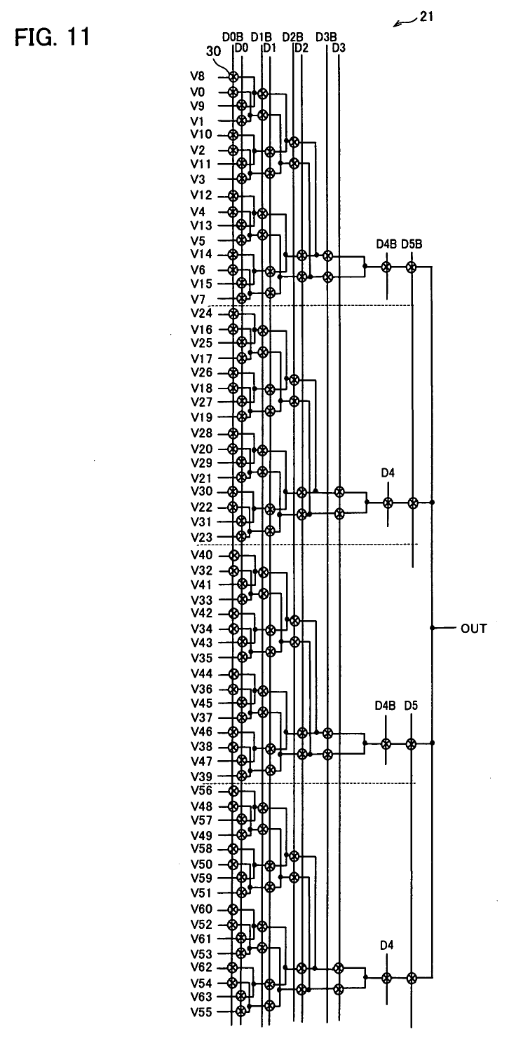

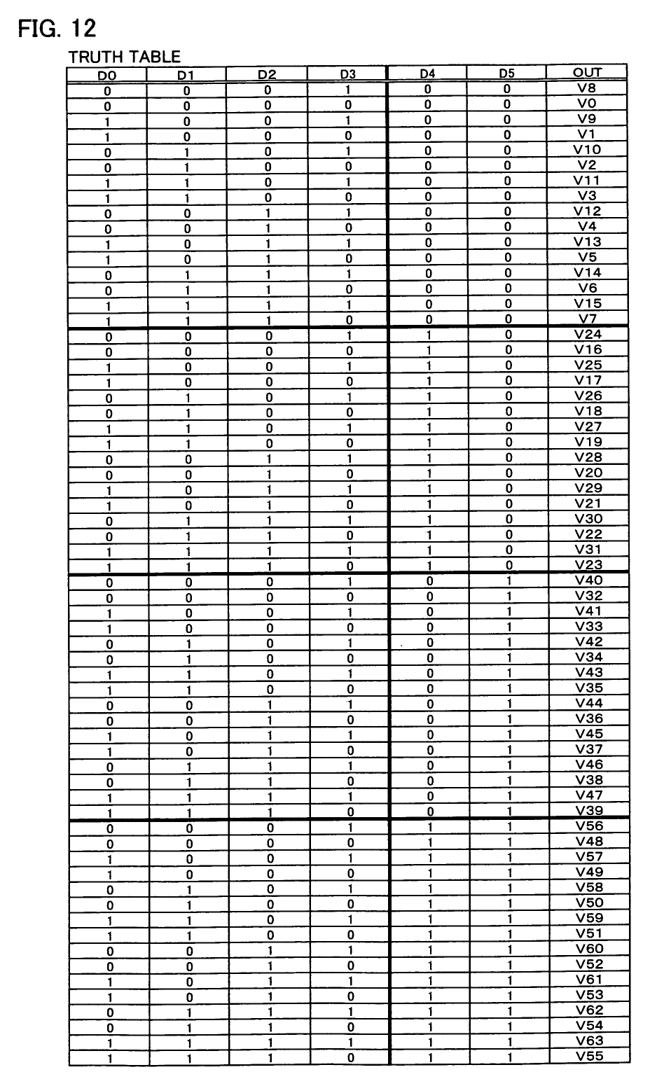

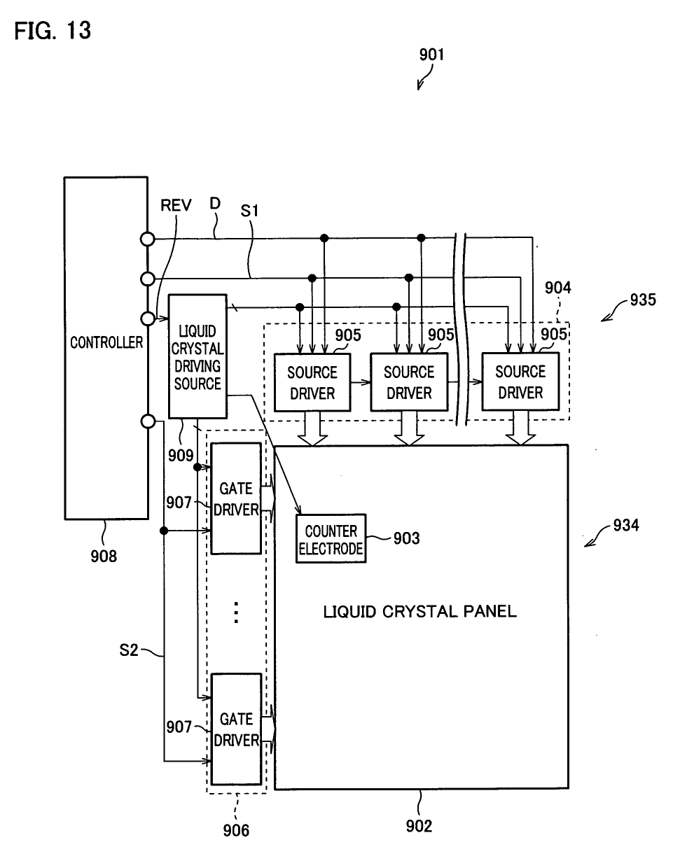

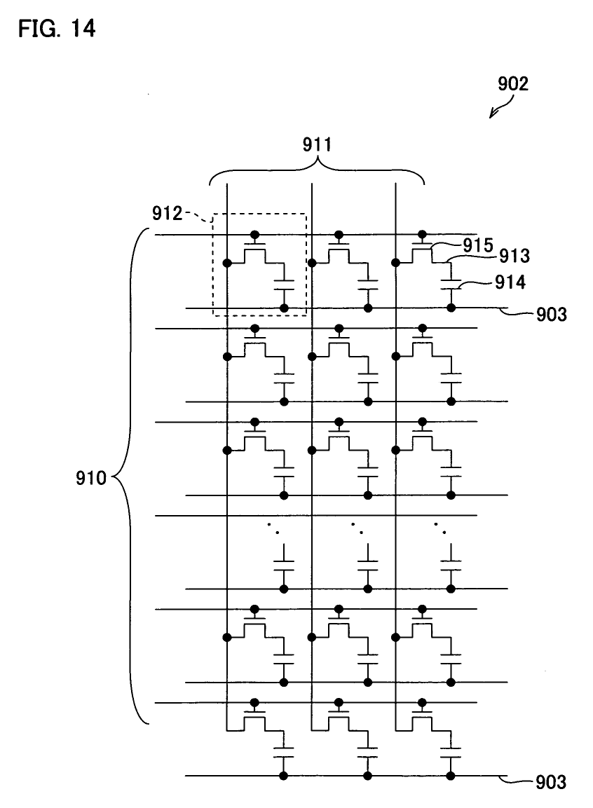

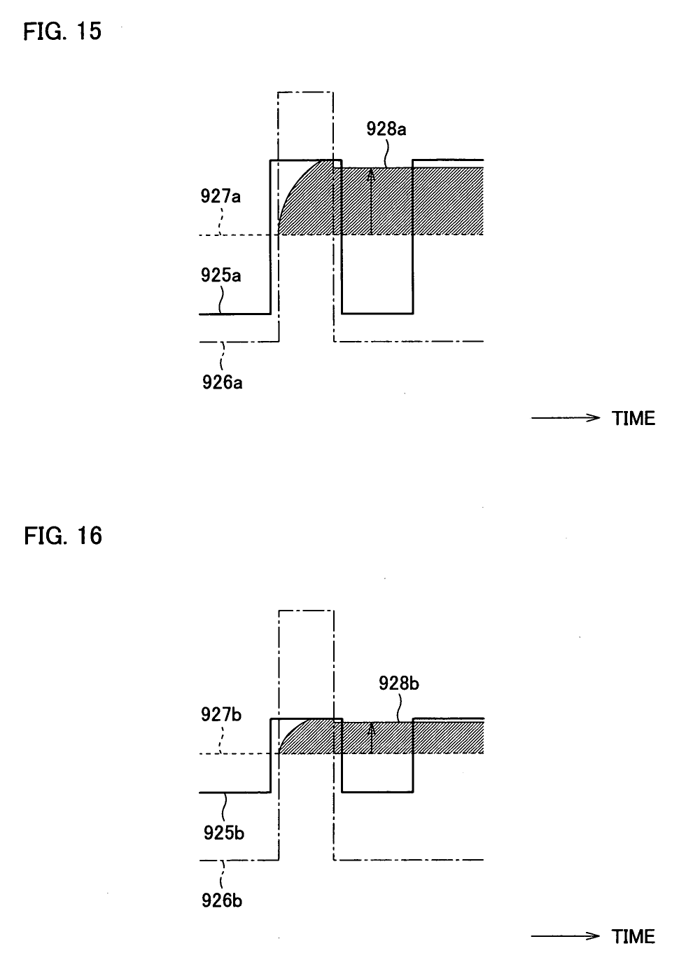

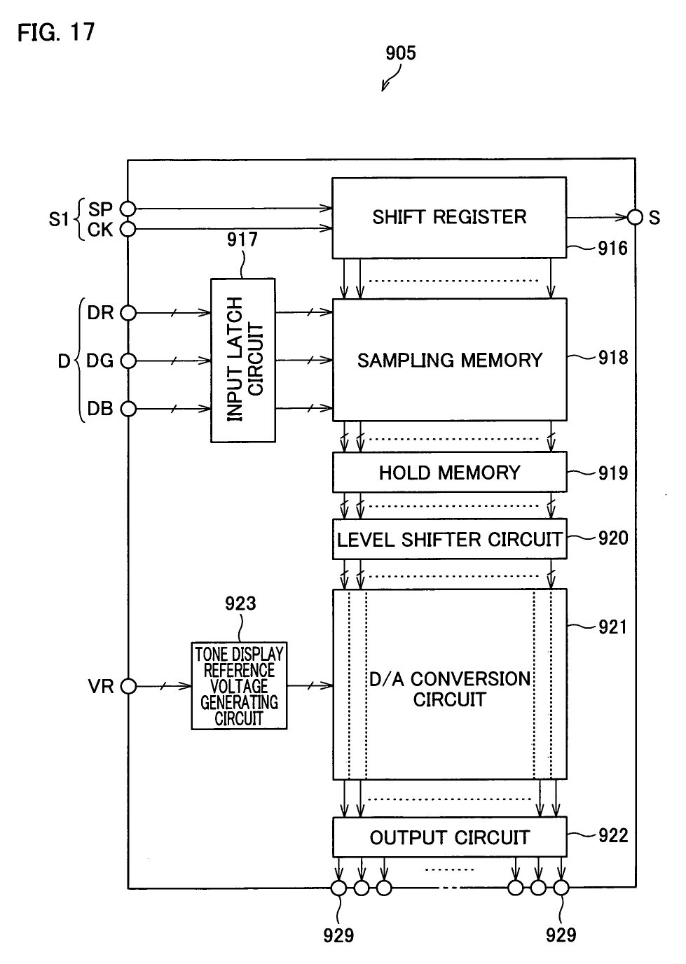

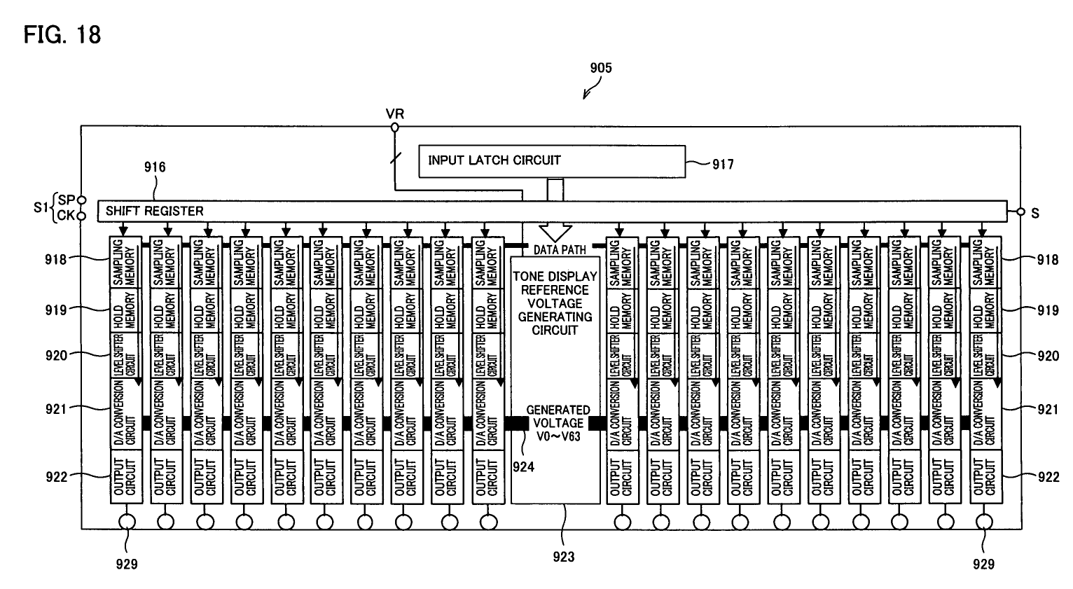

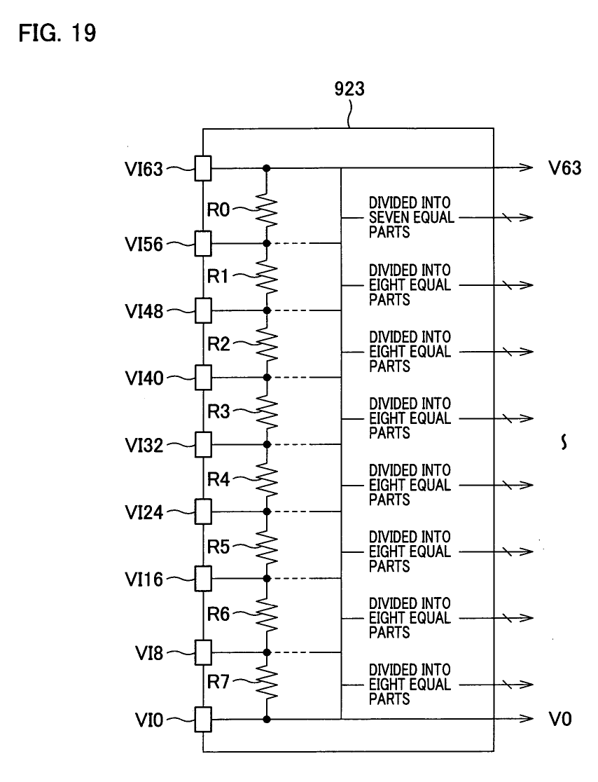

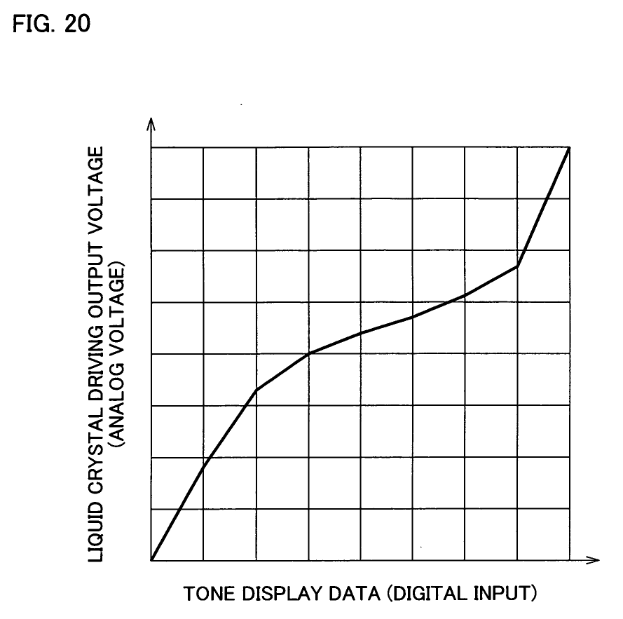

FIG. 11 is a circuit diagram illustrating another arrangement of the D/A conversion circuit 21 provided in the source driver 5. FIG. 12 is a truth table illustrating an operation of another arrangement of the D/A conversion circuit 21.

FIGS. 11 and 12 explain examples in which: the wire configuration determining method as described above with reference to FIGS. 8 to 10 is applied to 16 levels of tone display reference voltages V0 to V15, 16 levels of tone display reference voltages V16 to V31, 16 levels of tone display reference voltages V32 to V47, and 16 levels of tone display reference voltages V48 to V63, respectively. Each group of 16 levels of the tone display reference voltages is obtained by dividing tone display reference voltages corresponding to 64 tones into four equal groups. Development (reconfiguration) is performed with respect to reference voltage wires which correspond to 16 tones and which are in response to the signals D0, D1, D2, and D3.

The development (reconfiguration) is performed so that the reference voltage wires are configured in the following order.

Intermediate tone+1, primary tone, intermediate tone+2, primary tone+1, intermediate tone+3, primary tone+2, . . . , intermediate tone+number of tones/2-2, intermediate tone−2, intermediate tone+number of tones/2−1, intermediate tone−1, intermediate tone+number of tones/2, number of tones/2,

where the primary tone is a lowest-tone of successive tones to which the present invention is applied and is 1-tone or higher-tone, the successive tones being out of n tones including 1-tone to n-tone,

a last tone is a highest-tone of the successive tones and is 2-tone or higher-tone,

the primary tone, the last tone, and the n tone meet a relation of 1≦the primary tone<the last tone≦n-tone,

number of tones=the last tone−the primary tone+1 (the number of tones is an even number), and

the intermediate tone=the primary tone+the number of tones/2−1.

If the order is applied to 1 to 16 tones (V0 to V15), the primary tone is 1(V0) and the last tone is 15 (V16). The number of tones is 16−1+1=16 and intermediate tone is 1+16/2−1=8.

With the primary tone, the last tone, the number of tones, and the intermediate tone, the order of tones is calculated as follows (calculated tone number is shown in parentheses)).

Intermediate tone+1 (9), primary tone (1), intermediate tone+2 (10), primary tone+1 (2), intermediate tone+3 (11), primary tone+2 (3), . . . , intermediate tone+number of tones/2−2 (14), intermediate tone−2 (6), intermediate tone+number of tones/2−1 (15), intermediate tone−1 (7), intermediate tone+number of tones/2 (16), and intermediate tone (8).

A result of the development is expressed by tone signals as follows: V8, V0, V9, V1, V10, V2, . . . , V13, V5, V14, V6, V15, and V7, which is the order of configuration of V0 to V15 in FIG. 11.

In the same way, if the order is applied to 17 to 32 tones, then a primary tone is 17 (V16) and a last tone is 32 (V31). The number of tones is 32−17+1=16 and intermediate tone is 17+16/2−1=24, and the result is 25 (V24), 17 (V16), 26 (V25), 18 (V17), 27 (V26), 19 (V18), . . . , 30 (V29), 22 (V21), 31 (V30), 23 (V22), 32 (V31), 24 (V23), which is the order of configuration of V16 to V31 in FIG. 11.

The order of configuration of V32 to V47 and the order of configuration of V48 to V63 can be calculated in the same way.

As illustrated in FIG. 11, the development can be performed with respect to a part of n tones instead of a whole of n tones. With the arrangement, a potential difference corresponding to 8 tones or more exists between adjacent two reference voltage wires.

Note that, for convenience of explanation, an explanation was made as to the development method with reference to D/A conversion circuits corresponding to 64 tones. However, the present invention is not limited to this. The development method is effective with respect to D/A conversion circuits corresponding to tones more than 64 (e.g. 256 tones) and to D/A conversion circuits corresponding to tones less than 64 (e.g. 8 tones).

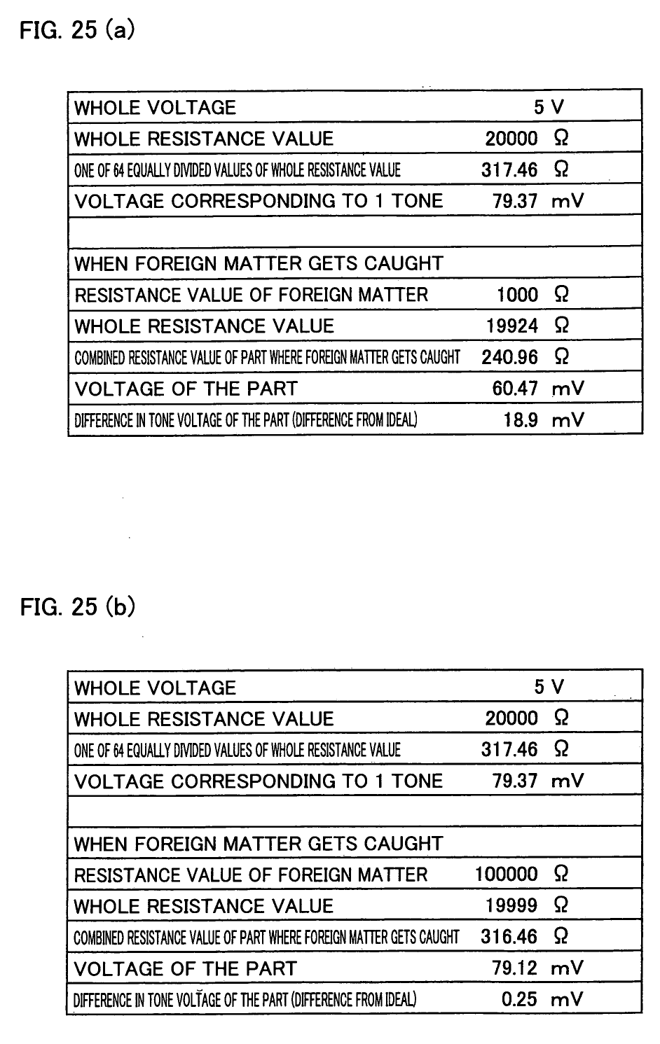

Further, an explanation was made as to a case where a potential difference corresponds to 32 tones or more between adjacent two reference voltage wires and a case where a potential difference corresponds to 8 tones or more between adjacent two reference voltage wires. However, the present invention is not limited to this. For example, in a case of FIG. 25(b), a potential difference may correspond to 2 tones or more between adjacent two reference voltage wires.

In a case where whole resistors and whole resistance values are those illustrated in FIG. 25(b), if reference voltage wires are configured in the order of 3-tone, 1-tone, 4-tone, and 2-tone so that a potential difference corresponds to 2 tones between the reference voltage wires, then a potential difference between a wire corresponding to 3-tone and a wire corresponding to 1-tone corresponds to 2 tones, and a potential difference between a wire corresponding to 4-tone and a wire corresponding to 2-tone corresponds to 2 tones. At that time, for example, if there is no foreign matter, then a potential difference corresponding to 2 tones between the wire corresponding to 3-tone and the wire corresponding to 1-tone is 158.74 mV (79.37 mV×2). If a foreign matter gets caught between the wires, then a value of a combined resistance between the wires is approximately 630.005Ω(1/((1/(317.46×2))+(1/100 k))≈630.005). Consequently, the resistance value changes from the original resistance value corresponding to 2 tones 634.92Ω (=317.46Ω×2) by 4.915Ω.

As a result, the whole resistance value changes from 20 kΩ to 19.995 kΩ. Therefore, a voltage between the wire corresponding to 3-tone and the wire corresponding to 1-tone at the part where the foreign matter gets caught is approximately 157.54 mV (5V×630.005Ω÷19.995 kΩ≈0.15754). Therefore, a change from the original voltage 158.74 mV is 1.20 mV (158.74 mV−157.54 mV=1.20 mV), which is larger than the resolution of the tester, namely, 1 mV. Therefore, it is possible to detect a foreign matter.

A foreign matter can be detected by the tone wire configuration method only when a short circuit already exists between wires. If a thin insulating film exists between wires, a foreign matter between the wires cannot be detected by an ordinal test. At that time, there is a possibility that the insulating film is broken during usage of a device and the foreign matter causes a short circuit. For that reason, a screening of a device is performed by a method called a stress test in which voltage fluctuation is applied on a part likely to be broken during usage of the device, so that the part is broken in advance, thereby preventing shipment of the device.

However, with the tone wire configuration method, although a difference in voltage between tone voltage wires is larger than that of a conventional wire configuration, if the maximum voltage of a tone voltage is the same as a driving voltage (VCC) of a device, a difference between voltages applied on tone voltage wires is VCC/2 at maximum. Therefore, there is room for improvement of efficiency in the stress test.

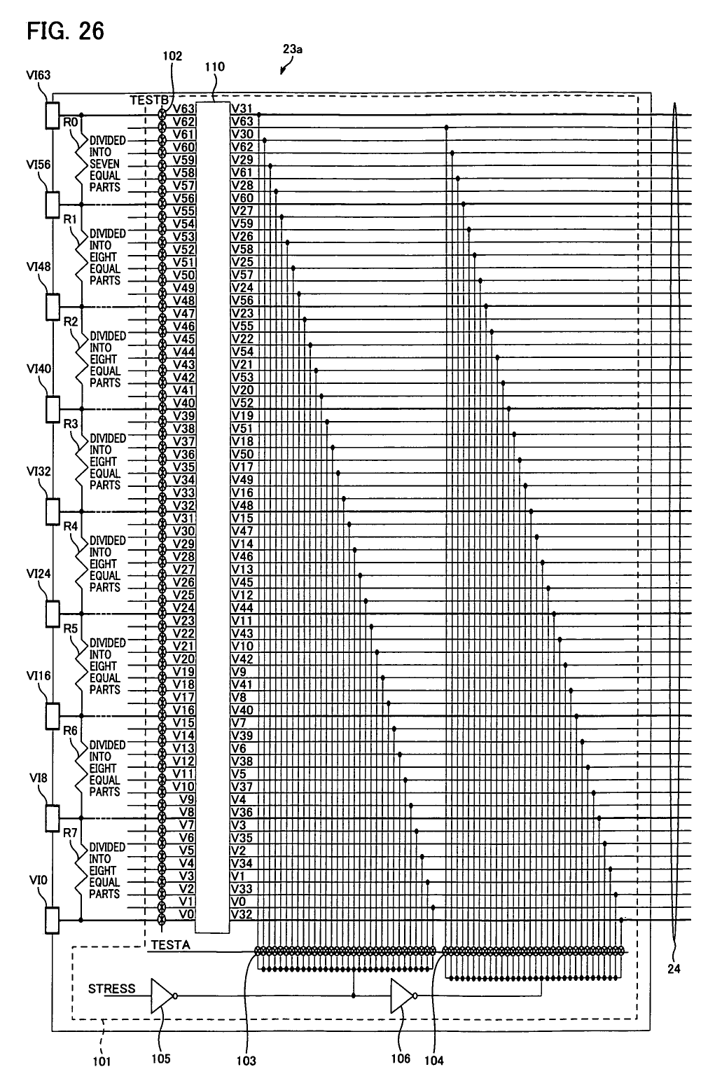

Therefore, in order to further improve an ability of the circuit of the present embodiment to detect a foreign matter, a test circuit illustrated in FIG. 26 is provided. FIG. 26 illustrates a tone display reference voltage generating circuit 23a in which a test circuit 101 for improving the ability to detect a foreign matter is added to the tone display reference generating circuit 23 in FIG. 7. Note that, a reference numeral 110 in FIG. 26 indicates a wire reconfiguration area, which is also provided in the tone display reference voltage generating circuit 23 in FIG. 7. Reconfiguration of wires is also performed in the tone display reference voltage generating circuit 23 in FIG. 7, but the reconfiguration is not shown in FIG. 7. In the wire reconfiguration area 110, wires corresponding to voltages V0 to V63 made by resistive division are reconfigured in the order illustrated in FIG. 8. In the wire reconfiguration area 110, the wires corresponding to the voltages V0 to V63 are reconfigured and are connected with each D/A conversion circuit 21. That is, the wires in a subsequent stage of the wire reconfiguration area 110 in FIG. 26 are in the same order as wires corresponding to V0 to V63 in a device in use. Note that, in FIG. 8, a wire corresponding to a voltage V32 is shown on top of the drawing and a wire corresponding to a voltage V31 is shown on bottom of the drawing, but in FIG. 26, in contrast, a wire corresponding to a voltage V31 is shown on top of the drawing and a wire corresponding to a voltage V32 is shown on bottom of the drawing.

The test circuit 101 includes: switches 102 for shutting, in a test mode, voltages generated in R0 to R7; switches 103 (first switches) and switches 104 (second switches) each supply, in the test mode, signals to terminals from which generated voltages 24 of V0 to V63 are generated; and inverters 105 and 106 for receiving a signal STRESS used to determine values of the generated voltages 24 in the test mode. Note that, an arrangement of each switch in the switches 103 and 104 is the same as an arrangement illustrated in FIG. 9(a).

In the test mode, a signal TEST A becomes “H” and a signal TEST B becomes “L”. Consequently, the switches 102 turn off and tone voltages generated in resistances R0 to R7 do not have influences on the generated voltages 24. A signal STRESS is a signal supplied from an outside of the tone display reference voltage generating circuit 23a in the test mode, and “H” level of the signal STRESS corresponds to an operation voltage of the tone display reference voltage generating circuit 23a, and “L” level of the signal STRESS corresponds to a GND level of the reference voltage generating circuit 23a. The signal STRESS is inverted by an inverter 5 and is supplied by the switches 103 which are ON in the test mode to odd wires in FIG. 26. The signal STRESS is further inverted by an inverter 6 and is supplied by the switches 104 which are ON in the test mode to even wires in FIG. 26.

That is, when the signal STRESS is in “H” level, voltages of odd tone wires which are supplied by the switches 103 are in “L” level (first voltage), and voltages of even tone wires which are supplied by the switches 104 are in “H” level (second voltage). In contrast, when the signal STRESS is in “L” level, voltages of odd tone wires which are supplied by the switches 103 are in “H” level, and voltages of even tone wires which are supplied by the switches 104 are in “L” level.

As described above, in the test mode, a difference in voltage between adjacent tone lines is a difference between the operation voltage of the device and the GND level, which difference is the maximum voltage difference in the device. By switching the signal STRESS between “H” and “L”, a stress with the maximum voltage is applied between the tone lines. Consequently, efficiency in screening increases.

In this way, by combining the tone wire configuration method with the method of the stress test, it is possible to further increase sensitivity in detecting a foreign matter between tone wires.

The present invention is not limited to the above embodiments, and a variety of modifications are possible within the scope of the following claims, and embodiments obtained by combining technical means respectively disclosed in the above embodiments are also within the technical scope of the present invention.

As means for realizing the configuration, it is preferable to arrange the display driving integrated circuit of the present invention so that the n reference voltage wires (n: an integer of two or more and is an even number) are configured in an order determined by: (n/2+1)-tone, 1-tone, (n/2+2)-tone, 2-tone, . . . , (n/2+(n/2−1))-tone, (n/2−1)-tone, (n/2+n/2)-tone, and (n/2)-tone.

With the arrangement, it is possible to alternately configure reference voltage wires corresponding to 1-tone to (n/2)-tone and reference voltage wires corresponding to (n/2+1)-tone to (n/2+n/2)-tone. Therefore, it is easy to configure n reference voltage wires so that a potential difference corresponds to two tones or more between adjacent two reference voltage wires.

Note that, the present embodiment is applicable to tones which are a part of n tones.

The present embodiment applicable to the tones which are a part of n tones is represented by an order determined by: intermediate tone+1, primary tone, intermediate tone+2, primary tone+1, intermediate tone+3, primary tone+2, . . . , intermediate tone+number of tones/2−2, intermediate tone−2, intermediate tone+number of tones/2−1, intermediate tone−1, intermediate tone+number of tones/2, and intermediate tone

where

the primary tone is a lowest-tone of an even number of successive tones out of n tones including 1-tone to n-tone and is 1-tone or higher-tone,

a last tone is a highest-tone of the even number of successive tones and is 2-tone or higher-tone,

1≦the primary tone<the last tone≦n-tone,

the number of tones=the last tone−the primary tone+1 (the number of tones is an even number), and

the intermediate tone=the primary tone+the number of tones/2−1.

It is preferable to arrange the display driving integrated circuit so that the tone display reference voltage generating circuit includes a test circuit which supplies, between adjacent two reference voltage wires, a potential difference corresponding to a driving voltage.

It is preferable to arrange the display driving integrated circuit so that the test circuit includes first switches which supply a first voltage to respective odd reference voltage wires of the n reference voltage wires, and second switches which supply a second voltage to respective even reference voltage wires of the n reference voltage wires, a potential difference corresponding to the driving voltage existing between the first voltage and the second voltage.

The present invention is applicable to (i) a display driving integrated circuit which includes: a tone display reference voltage generating circuit for generating tone display reference voltages corresponding to tone levels; D/A conversion circuits each for performing an analog conversion with respect to display data on the basis of the tone display reference voltages; and reference voltage wires via which the tone display reference voltages are supplied to the D/A conversion circuits, and (ii) a method for determining a wire configuration of the display driving integrated circuit.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A display driving integrated circuit, comprising:
a tone display reference voltage generating circuit for generating n tone display reference voltages (n: an integer of two or more);
D/A conversion circuits each for performing an analog conversion with respect to display data, based on the n tone display reference voltages; and
n reference voltage wires, provided in parallel, via which the n tone display reference voltages are supplied to the D/A conversion circuits, respectively,
the n reference voltage wires being configured so that a potential difference corresponds to two tones or more between adjacent two reference voltage wires.

2. The display driving integrated circuit as set forth in claim 1, wherein
said n is an integer of two or more and is an even number, and
the n reference voltage wires are configured in an order determined by: (n/2+1)-tone, 1-tone, (n/2+2)-tone, 2-tone, . . . , (n/2+(n/2−1))-tone, (n/2−1)-tone, (n/2+n/2)-tone, and (n/2)-tone.

3. The display driving integrated circuit as set forth in claim 1, wherein
reference voltage wires corresponding to an even number of successive tones out of n tones including 1-tone to n-tone are configured in an order determined by: intermediate tone+1, primary tone, intermediate tone+2, primary tone+1, intermediate tone+3, primary tone+2, . . . , intermediate tone+number of tones/2−2, intermediate tone−2, intermediate tone+number of tones/2−1, intermediate tone−1, intermediate tone+number of tones/2, and intermediate tone,
where
the primary tone is a lowest-tone of the even number of successive tones and is 1-tone or higher-tone,
a last tone is a highest-tone of the even number of successive tones and is 2-tone or higher-tone,
1≦the primary tone<the last tone≦n-tone,
the number of tones=the last tone−the primary tone+1 (the number of tones is an even number), and
the intermediate tone=the primary tone+the number of tones/2−1.

4. A method for determining a wire configuration of a display driving integrated circuit, comprising the step of determining a configuration of n (n: an integer of two or more) reference voltage wires provided in parallel, via which voltage wires n tone display reference voltages are supplied, so that a potential difference corresponds to two tones or more between adjacent two reference voltage wires.

5. The method as set forth in claim 4, wherein
said n is an integer of two or more and is an even number, and
the n reference voltage wires are configured in an order determined by: (n/2+1)-tone, 1-tone, (n/2+2)-tone, 2-tone, . . . , (n/2+(n/2−1))-tone, (n/2−1)-tone, (n/2+n/2)-tone, and (n/2)-tone.

6. The method as set forth in claim 4, wherein
reference voltage wires corresponding to an even number of successive tones out of n tones including 1-tone to n-tone are configured in an order determined by: intermediate tone+1, primary tone, intermediate tone+2, primary tone+1, intermediate tone+3, primary tone+2, . . . , intermediate tone+number of tones/2−2, intermediate tone−2, intermediate tone+number of tones/2-1, intermediate tone−1, intermediate tone+number of tones/2, and intermediate tone,
where
the primary tone is a lowest-tone of the even number of successive tones and is 1-tone or higher-tone,
a last tone is a highest-tone of the even number of successive tones and is 2-tone or higher-tone,
1≦the primary tone<the last tone≦n-tone,
the number of tones=the last tone−the primary tone+1 (the number of tones is an even number), and
the intermediate tone=the primary tone+the number of tones/2−1.

7. The display driving integrated circuit as set forth in claim 1, wherein the tone display reference voltage generating circuit includes a test circuit which supplies, between adjacent two reference voltage wires, a potential difference corresponding to a driving voltage.

8. The display driving integrated circuit as set forth in claim 7, wherein
the test circuit includes
first switches which supply a first voltage to respective odd reference voltage wires of the n reference voltage wires, and
second switches which supply a second voltage to respective even reference voltage wires of the n reference voltage wires, and
a potential difference corresponding to the driving voltage exists between the first voltage and the second voltage.
